(19) United States
(12) Patent Application Publication
(10) Pub. No.: US 2025/0068004 A1
(43) Pub. Date: Feb. 27, 2025

(54) Reconfigurable optical processor

(71) Applicant: Keisuke Kojima, Weston, MA (US)

(72) Inventor: Keisuke Kojima, Weston, MA (US)

(21) Appl. No.: 18/236,400

(22) Filed: Aug. 22, 2023

(51) Int. Cl. G02F 1/13; G02F 1/21

(52) U.S. Cl. CPC G02F 1/1326; G02F 1/212

(57) ABSTRACT

A reconfigurable optical processor is provided for processing optical signals. The device includes at least two input ports configured to receive input signals including at least one primary wavelength, a nanophotonic structure configured to separate the input beams into at least two beams, wherein the reconfigurable optical processor includes a lower electrode at the bottom, a substrate on the lower electrode, a cladding layer on the substrate, a nanophotonic structure waveguide layer, support materials to hold the insulating layer and the substrate, an upper electrode on the insulating layer, a variable refractive index layer arranged to fill gaps between the substrate, the nanophotonic structure, and the insulating layer; and at least two output ports configured to transmit at least two beams propagated.

This application claims the benefit of U.S. Provisional Application No. 63/400,538, filed on 24 Aug. 2022.

### FIELD OF THE INVENTION

The present invention pertains to the domain of optoelectronics. More specifically, it is centered on a reconfigurable optical processor designed to offer integrated photonics optical devices. These devices are particularly suited for applications in optical neural networks, optical quantum computing, and optical signal processing.

### BACKGROUND OF THE INVENTION

Traditional machine learning architectures lean heavily on artificial neural networks (ANNs), drawing inspiration from the brain's signal processing mechanisms. While these ANNs have been traditionally constructed using electronic components, primarily anchored in CMOS-related technologies, there is a shift towards Optical Neural Networks (ONNs). ONNs are essentially physical renditions of ANNs, leveraging optical components as their foundational blocks. Recent developments have witnessed the rise of ONNs assembled using discrete optical components tailored to execute specific ONN functions. Such ONNs manifest as photonic-enabled machine learning processors, boasting computation speeds far surpassing those of electronic integrated circuits—sometimes achieving clock rates exceeding 10 Giga-Hertz (GHz) or delving into picosecond-scale computational speeds. The basis for photonic signal processing can be discrete optical components, or a fusion of these components with a photonic integrated circuit.

Central to the ONNs are the ubiquitous reconfigurable 2×2 optical processors. A prevalent design involves the Mach-Zehnder interferometer, incorporating two 2×2 splitters and typically one or two adaptable phase shifters. These are often fabricated on a silicon photonics platform using either silicon or silicon nitride waveguides. These reconfigurable optical processors are versatile, capable of executing a myriad of optical functions. When networked, they hold the potential for both machine learning and quantum computing applications.

However, one major drawback of the conventional reconfigurable optical processors is that the device size is very large, typically more than one millimeter in length, mainly due to the large size of phase shifters based on the refractive index change by the thermal effects, and the size of 2×2 optical splitters. Therefore, a very different device structure is needed.

### SUMMARY OF THE INVENTION

The present invention includes two or more input waveguides and two or more output waveguides, and a nanophotonic structure creating an optical interference, wherein the nanophotonic structure is covered with a material whose refractive index can be controlled externally. The transmission characteristics from the input ports to the output ports are wavelength dependent and can be reconfigured externally. The nanophotonic structure is inverse designed such that the desirable optical transmission characteristics can be obtained by the different state of the control signal.

Some embodiments of the present disclosure are silicon photonics reconfigurable optical processors based on an inverse designed nanophotonic structure covered by liquid crystal (LC) whose refractive index is controlled by the applied voltage.

Some embodiments of the present disclosure are silicon photonics reconfigurable optical processors based on an inverse designed nanophotonic structure covered by chalcogenide material whose refractive index can be modified by heat caused by a heater or illuminated laser light.

### BRIEF DESCRIPTION OF DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows the schematic of the prior art wherein the 2×2 optical processor consists of a Mach-Zehnder interferometer with two 2×2 optical splitters and two reconfigurable phase shifters;

FIG. 2 shows the schematic top view of the waveguide structure of reconfigurable optical processor, according to the embodiment of the present invention;

FIG. 3 shows the schematic of the cross-sectional view of the reconfigurable optical processor, according to the embodiment of the present invention;

FIG. 4 shows the simulated transmittance spectrum from input port 1 to output port 1 and output port 2, with the LC voltage on or off;

FIG. 5 shows the simulated transmittance from input port 1 to output port 1 and output port 2 with the input wavelength λ1;

FIG. 6 shows the simulated transmittance from input port 1 to output port 1 and output port 2 with the input wavelength λ2;

FIG. 7 illustrates the simulated differential transmittance at wavelengths λ1 and λ2, depicting transmission from input port 1 to output port 1 as well as from input port 1 to output port 2;

FIG. 8 shows the cross-sectional view wherein a waveguide layer has remaining thickness below the nanophotonic structure;

FIG. 9 shows the cross-sectional view wherein has remaining thickness below the nanophotonic structure and is connected to an electrode;

FIG. 10 shows the cross-sectional view wherein a chalcogenide glass is used for variable refractive index layer;

FIG. 11 shows the top view of the reconfigurable optical processor wherein one of the output ports has a variable phase shifter;

### DETAILED DESCRIPTION OF THE INVENTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Furthermore, embodiments of the subject matter disclosed may be implemented, by use of at least in part, or combinations of parts of the structures described below.

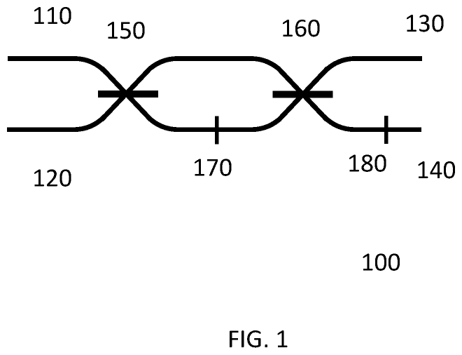

FIG. 1 is the present invention of a reconfigurable 2×2 optical processor 100 with two input ports 110 and 120, and two output ports 130 and 140 based on a Mach-Zehnder interferometer. Two beamsplitters 150 and 160 each are used to combine two beams and split into two beams with 50:50 splitting ratio. By adjusting the phase shifter 170, the splitting ratio between the two output ports 130 and 140, as well as the common phase. The second phase shifter 180 creates a phase shift only to the output 140, and is used when the relative phase between output ports 130 and 140 is important, in such application as N×N reconfigurable optical processor based on the cascaded 2×2 reconfigurable optical processors, where N is greater than 2.

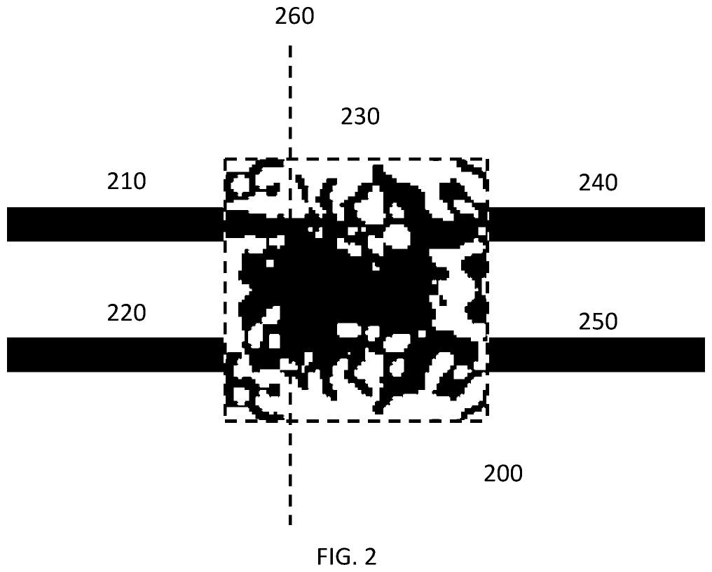

FIG. 2 is the top view of the reconfigurable optical processor 200 including two input ports 210 and 220, a nanophotonic structure 230 covered by LC as a variable refractive index layer, an insulating layer, and an upper electrode, and two output ports 240 and 250.

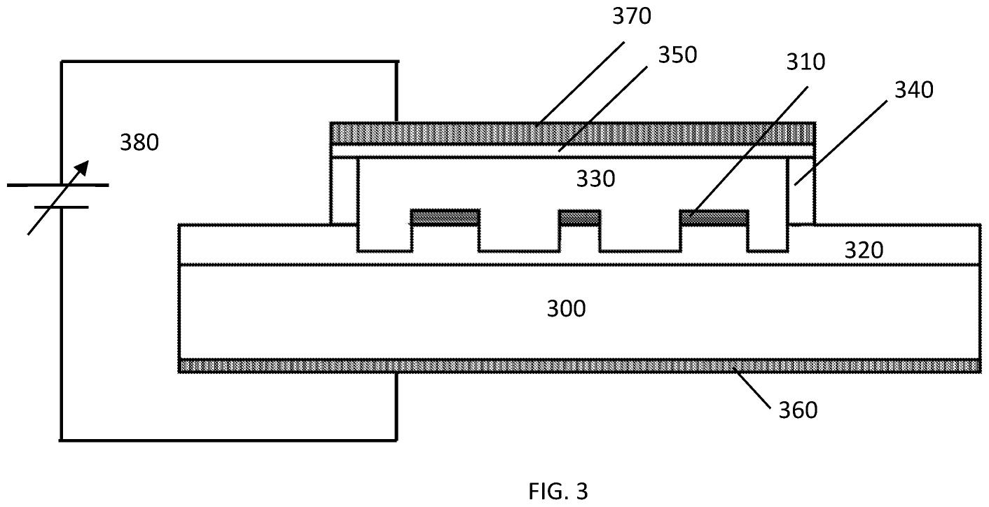

FIG. 3 is the cross-sectional view of the reconfigurable optical processor 200 along the line 260, wherein a silicon substrate 300, a silicon waveguide layer 310, a silicon dioxide cladding layer 320, LC layer 330, a spacer 340, an insulating layer 350, a lower electrode 360, an upper electrode 370 and a voltage source 380 to be applied between the lower electrode 360 and the upper electrode 370.

Using a commercial finite-difference time-domain (FDTD) simulation tool by Lumerical and the LumOpt adjoint method optimization package, the nanophotonic structure was optimized. The size of the nanophotonic structure used for the simulation is 4.5 μm×4.5 μm and the pixel size are 25 nm×25 nm. A two-dimensional FDTD based on the effective refractive index method is used. The waveguide layer consists of 220 nm-thick silicon. The width of the input and output ports is 50 nm, and the distance between the two input ports and that between the two output ports is 2.25 μm. Note that larger nanophotonic structure size generally gives better performance. Note that the FDTD simulation results are based on the nanophotonic structure size of 4.5 μm×4.5 μm, however, the transmission characteristics generally improves with a larger size.

The molecule direction of LC can be manipulated by an electric field applied to the material, and the anisotropic refractive index is controlled by the molecule directional change. For the simulation, the refractive index is 1.69 along the long axis and is 1.50 in other directions at the wavelength of 1.55 μm.

We define T1(λ) as the transmittance from input port 1 to output port 1, and T2(λ) as that from input port 1 to output port 2, both as a function of wavelength λ. LC ON is a state in which the voltage across the LC layer is applied and the long axis direction is along the out-of-plane. LC OFF is a state in which the voltage is not applied, and the long axis is in the plane and perpendicular to the input waveguide. The optimization of the nanophotonic structure is conducted such that the T1(λ1)+T2(λ2)−T1(λ2)−T2(λ1) at the LC ON state is maximized, while that at the LC OFF state is minimized. Here, we used λ1=1525 nm and λ2=1575 nm. If the optimized pattern is substantially symmetric along the axis of the input waveguide, then we expect that the transmittance from input port 2 to output port 1 is substantially identical to that from input port 1 to output port 2.

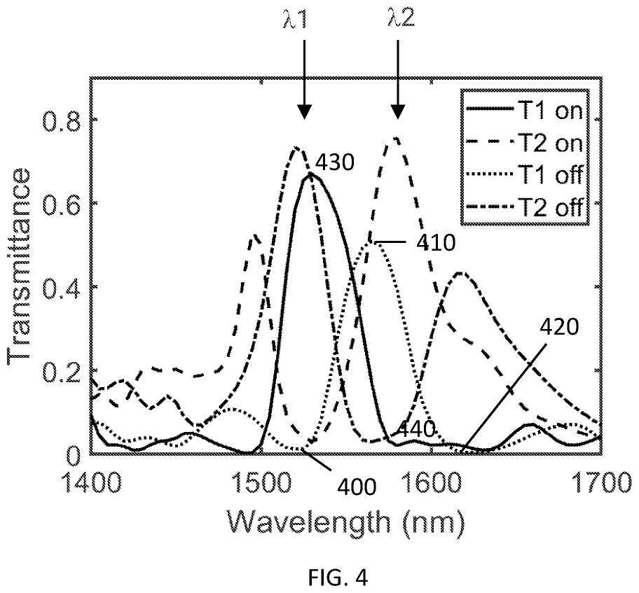

FIG. 4 shows the transmittances T1 and T2 of various conditions as a function of wavelength I, when LC is ON or OFF. For T1 with LC OFF, there is a valley near λ1 (400), a peak near λ2 (410) and a valley at around 1625 nm (420). When LC is ON, the peak shifts towards λ1 (430) and the right valley shifts towards λ2 (440). In other words, it is imperative for the T1 spectrum to have one distinct peak and two distinct valleys. These move according to the applied voltage and create sharp transmittance changes. For T2 with LC OFF, there is a peak near λ1, valley near λ2, and a lower peak at around 1620 nm. The peak at around 1620 nm is shifted to a larger peak at λ2, and the valley near λ2 is shifted to λ1. It is imperative for the T2 spectrum to have one distinct valley and two distinct peaks.

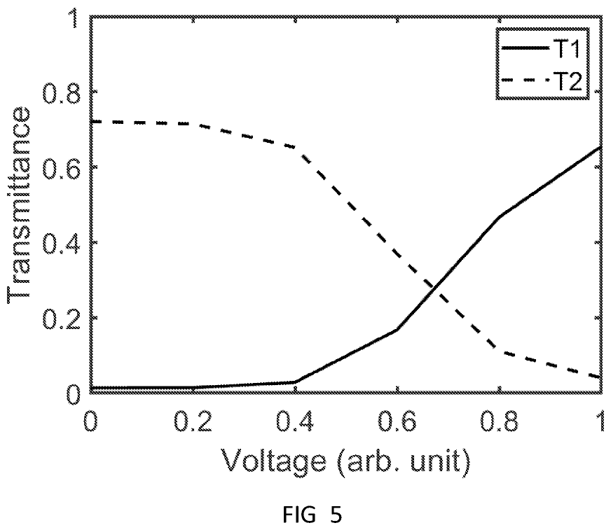

FIG. 5 shows the transmittance T1 and T2 at λ1. At this wavelength, as the applied voltage to the LC increases, T1 increases, and T2 decreases. In other words, the input signal to the input port 1 at the wavelength of λ1 moves from output port 2 to output port 1 with increasing the voltage.

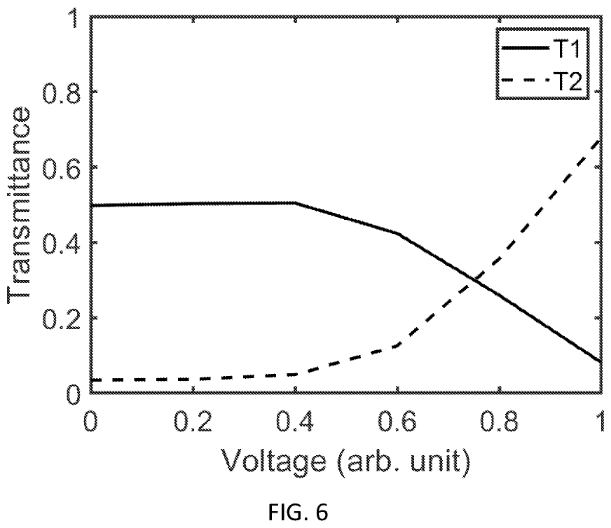

FIG. 6 shows the transmittance T1 and T2 at λ2. At this wavelength, as the applied voltage to the LC increases, T1 decreases, and T2 increases. In other words, the input signal to the input port 1 at the wavelength of λ2 moves from output port 1 to output port 2 with increasing the voltage.

In one embodiment of the invention, only one wavelength is used as an input signal, and this reconfigurable optical processor directs the input signal to either or both of the output ports depending on the applied voltage to the IC.

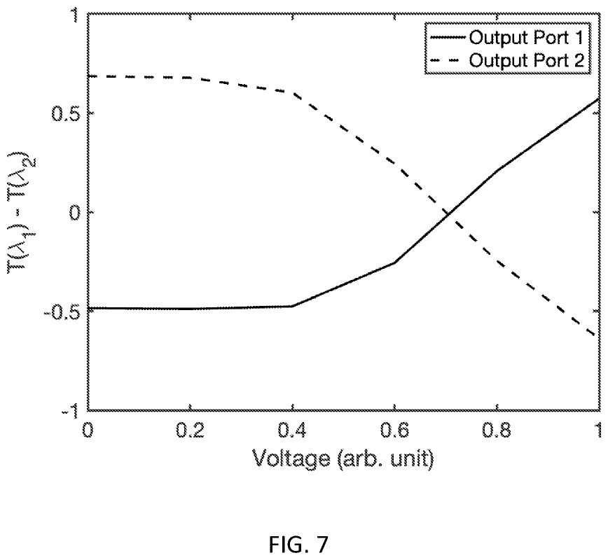

In another embodiment of the invention, two wavelengths are utilized as complementary signals to represent positive and negative values. Specifically, FIG. 7 represents the combined results of FIGS. 5 and 6, detailing the differential transmittance between T1 and T2 at wavelengths λ1 and λ2. By maintaining input signal levels at wavelengths λ1 and λ2 at input port 1 and assigning the signal at λ1 as the positive representation, the flowing observation cam be made:
When a low voltage is applied, the signal intensity at output port 1 for λ1 is less than that for λ2, indicating a negative signal.
Conversely, when a high voltage applied to the LC, the signal intensity at output port 1 for λ1 is higher than that of λ2, indicating a positive signal.
As the applied voltage is incremented, the signal at output port 1 transition to a positive value, while the signal at output port 2 becomes negative.

In another embodiment of the invention, ferroelectric LC may be used to form a LC layer 330. Typically, the molecule of LC is brought to the original orientation when the applied electric field is released. Ferroelectric LCs retains their molecular orientation for a long time even when the applied electric field is removed, enabling non-volatile operation without continuous applied field.

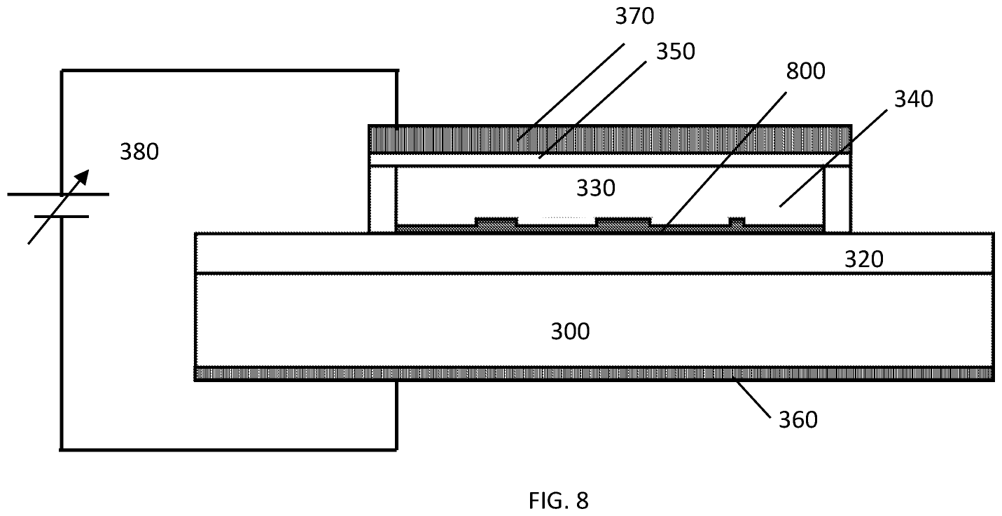

In another embodiment of the invention, FIG. 8 is the cross-sectional view of the reconfigurable optical processor 200 along the line 260, wherein a nanophotonic structured silicon waveguide layer 800 is continuous with partially etched regions, and the LC layer 340 does not reach the silicon dioxide cladding layer 320. Compared with the case of FIG. 3, there is less optical scattering loss since the nanophotonic structure waveguide layer is continuous, while the optical field feels less of the refractive index change of the LC layer 340 and the effect of controllability is reduced.

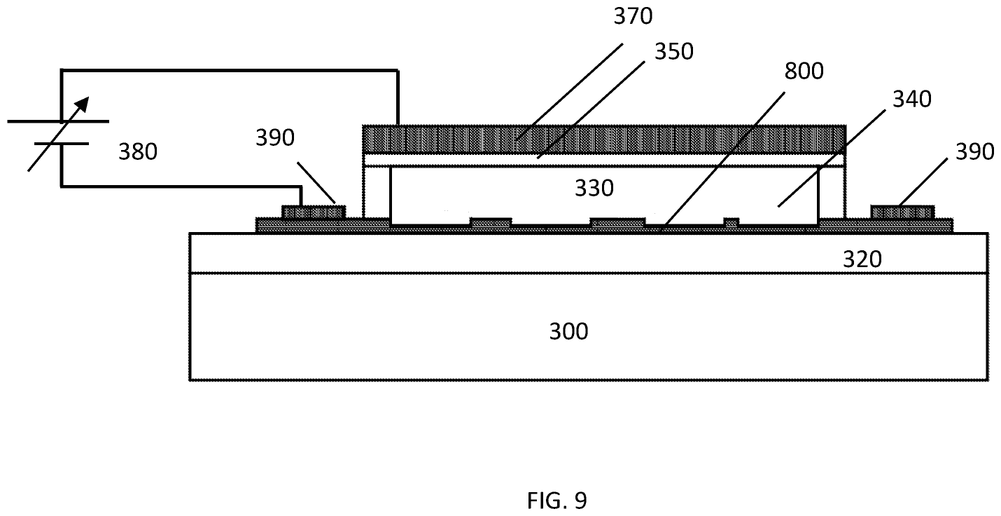

In another embodiment of the invention, FIG. 9 is the cross-sectional view of the reconfigurable optical processor 200 along the line 260, wherein a nanophotonic structured silicon waveguide layer 700 is continuous with partially etched regions, and the LC layer 340 does not reach the silicon dioxide cladding layer 320. Compared with the case of FIG. 8, the silicon layer is connected to a bottom electrode 390, and an electric field can be applied by an external voltage 380.

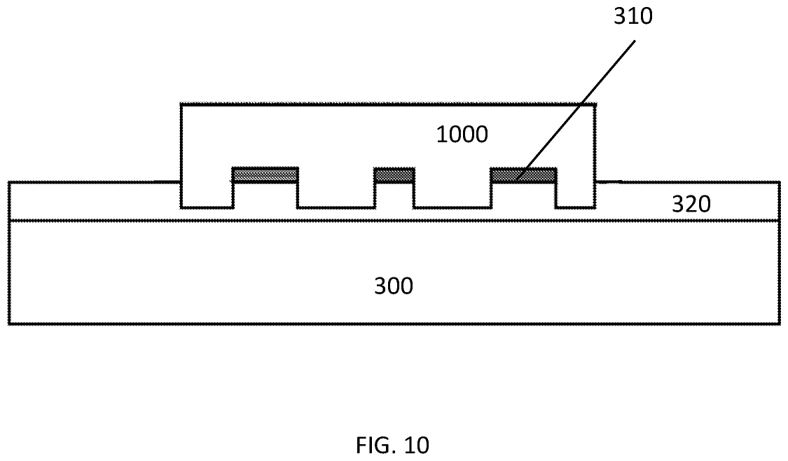

In another embodiment of the invention, chalcogenide glass can be used instead of the LC. FIG. 10 shows the cross-sectional view of the nanophotonic structure in which a chalcogenide glass 1000 constitute the reconfigurable refractive index layer. Their refractive indices can be controlled by applying temporal heating created by strong pulsed light. The change of refractive index is non-volatile. Like in the case of FIG. 8, the nanophotonic structured silicon waveguide layer can be continuous, or can be non-continuous as in the case of FIG. 2.

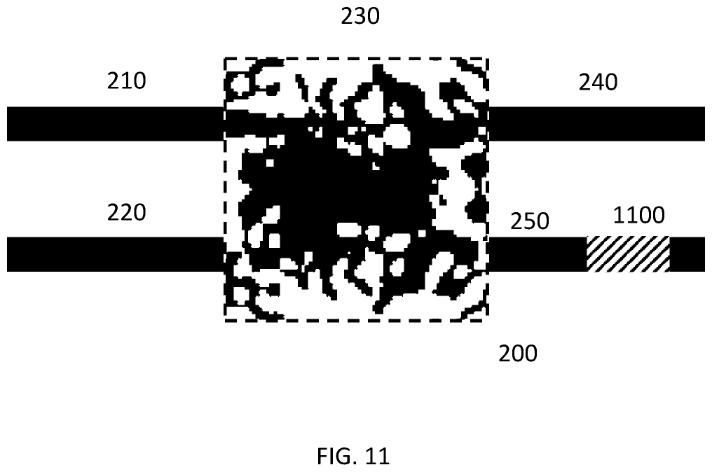

In another embodiment of the invention, FIG. 11 shows a reconfigurable optical processor with a variable phase shifter 1100 inserted at one of the output ports. This variable phase shifter comprises of a waveguide loaded with a LC layer, chalcogenide glass, or any other material with controllable refractive index. With this configuration, a network of the reconfigurable optical processor can perform arbitrary Unitary operations required for optical neural networks and optical quantum computers.

1. A reconfigurable optical processor for directing multiple optical beams to various output ports, comprising:
a minimum of two input ports designed to accept multiple input beams;
a tunable nanophotonic structure, characterized by:
its ability to direct the multiple input beams into at least two distinct beams, wherein each route is tailored to transmit one primary wavelength of the input beams,
a substrate,
distinct core segments laid out on the substrate,
an upper layer,
supporting structures connecting the substrate to the upper layer,
a controllable refractive index layer, filling the voids between the substrate, supporting structures, and the upper layer; and
a minimum of two output ports for the transmission of the beams directed through their respective routes.

2. A reconfigurable optical processor of claim 1, wherein the tunable nanophotonic structure further comprises of
a top electrode located on the upper layer, and
an electrode which is separated from the top electrode.

3. The reconfigurable optical processor of claim 2, wherein the core segments have the capability to reconfigure the specific routes upon the application of an electric field to the controllable refractive index layer, utilizing the top electrode and electrode interfacing with the substrate.

4. The reconfigurable optical processor of claim 2, wherein the controllable refractive index layer is a liquid-crystal (LC).

5. The reconfigurable optical processor of claim 2, wherein the substrate is a silicon-on-insulator substrate.

6. The reconfigurable optical processor of claim 2, wherein the controllable refractive index layer is covered by an electrode.

7. The reconfigurable optical processor of claim 2, wherein the controllable refractive index layer includes of ferroelectric LC.

8. The reconfigurable optical processor of claim 1, wherein the controllable refractive index layer includes of a chalcogenide material.

9. The reconfigurable optical processor of claim 1, wherein the waveguide layer comprises of silicon.

10. The reconfigurable optical processor of claim 1, wherein the waveguide layer comprises of silicon nitride.

11. A reconfigurable optical processor of claim 1, wherein the signal at each output port is a differential signal at two separate wavelength.

12. A reconfigurable optical processor of claim 1, wherein the nanophotonic structure has the size of at least 4.5 μm×4.5 μm.

13. A reconfigurable optical processor of claim 1, wherein the inverse design process of the nanophotonic structure includes the evaluation function substantially similar to [T1(λ1)+T2(λ2)−T1(λ2)−T2(λ1)] LC=ON−[T1(λ1)+T2(λ2)−T1(λ2)−T2(λ1)] LC=OFF, where T1 and T2 are the transmission characteristics from one of the input ports to two separate output ports 1 and 2, λ1 and λ2 are the two distinct wavelength, and LC=ON is a state where the liquid state is in the ON state, while LC=OFF is a state where LC is in the OFF state.

13. A reconfigurable optical processor of claim 1, wherein the transmission spectrum from one of the input ports to one of the output ports has at least two valleys while that to another output port has at least two peaks, wherein the peaks and valleys move in the same direction with respect to the wavelength according to the refractive index change of the layer covering the nanophotonic structure.
